(19) United States
(12) Patent Application Publication
(10) Pub. No.: US 2010/0329370 A1
(43) Pub. Date: Dec. 30, 2010

(54) Selection of a Subset of Antennas for Transmission

(75) Inventors: Bertrand Hochwald, Santa Clara, CA (US); Louay Jalloul, Santa Clara, CA (US); Arogyaswami Paulraj, Santa Clara, CA (US)

Correspondence Address: Beceem Communications, Inc., P.O. Box 6585, Santa Clara, CA, 95056-6585, US

(73) Assignee: BECEEM COMMUNICATIONS INC., Santa Clara, CA (US)

(21) Appl. No.: 12/765,686

(22) Filed: Apr. 22, 2010

Related U.S. Application Data
(60) Provisional application No. 61/214,853, filed on Apr. 28, 2009.

(51) Int. Cl. H04K 1/10

(52) U.S. Cl. 375/260

(57) ABSTRACT

A method and apparatus of a subscriber station selecting a subset of a plurality of antennas for uplink transmission are disclosed. One method includes a base station transmitting a cyclic delay diversity transmission signal. The subscriber station receives the cyclic delay diversity transmission signal through the plurality of antennas. The subscriber station selects a subset of the plurality of antennas based on a received quality signal parameter. The subscriber station transmits uplink signals to the base station through the selected subset of the plurality of antennas.

### RELATED APPLICATIONS

This patent application claims priority to U.S. provisional patent application Ser. No. 61/214,853 filed on Apr. 28, 2009 which is incorporated by reference.

### FIELD OF THE DESCRIBED EMBODIMENTS

The described embodiments relate generally to wireless communication. More particularly, the described embodiments relate to methods and systems for selecting a subset of antennas for transmission.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, Worldwide Interoperability for Microwave Access (WiMAX), and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Transmit diversity schemes may be used for enhancing communication reliability in a wireless multiple-access communication system. It is desirable to improve the antennas selection of transmit diversity schemes.

### SUMMARY

An embodiment includes a method of a subscriber station selecting a subset of a plurality of antennas for uplink transmission. The method includes a base station transmitting a cyclic delay diversity transmission signal. The subscriber station receives the cyclic delay diversity transmission signal through the plurality of antennas. The subscriber station selects a subset of the plurality of antennas based on a received quality signal parameter. The subscriber station transmits uplink signals to the base station through the selected subset of the plurality of antennas.

Another embodiment includes a method of a subscriber station selecting a subset of a plurality of antennas for uplink transmission. The subscriber station receives the cyclic delay diversity transmission signal through the plurality of antennas. The subscriber station selects a subset of the plurality of antennas based on a received quality signal parameter. The subscriber station transmits uplink signals to the base station through the selected subset of the plurality of antennas.

Another embodiment includes a wireless system. The wireless system includes an uplink base station transmitting a cyclic delay diversity transmission signal. A subscriber station receives the cyclic delay diversity transmission signal through the plurality of antennas. The subscriber station includes a plurality of antennas, and is operative to select a subset of the plurality of antennas based on a received quality signal parameter. The subscriber station is operative to transmit uplink signals to the base station through the selected subset of the plurality of antennas.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a wireless system that includes a multiple antenna base station transmitting Cyclic Delay Diversity downlink signals to a multiple antenna subscriber station, wherein the subscriber station selects a subset of its antennas for uplink transmission.

FIG. 2 shows an example of an OFDM (orthogonal frequency division multiplexing) wireless system that includes a multiple antenna base station transmitting Cyclic Delay Diversity downlink signals to a multiple antenna subscriber station.

FIG. 3 is a flow chart that includes steps of an example of a method of a subscriber station selecting a subset of a plurality of antennas for uplink transmission.

FIG. 4 is a flow chart that includes steps of an example of a method of a second transceiver selecting a subset of a plurality of antennas for second direction transmission.

### DETAILED DESCRIPTION

Embodiments of systems, methods and apparatuses for combining CDD (cyclic delay diversity) transmission in a first-direction link, and antenna selection for a second-direction link are disclosed. The combination provides for improved wireless link performance.

The embodiments describe generally teach a first-direction link being CDD. However, it is to be understood that other equivalent embodiments exist. For example, rather than pure CDD, an embodiment includes cyclic amplitude diversity. This can include a combination of CDD and amplitude variability, and allows the amplitude on each antenna to change as a function of time and/or tone. An alternate form introduces a phase rotation on each transmit antenna.

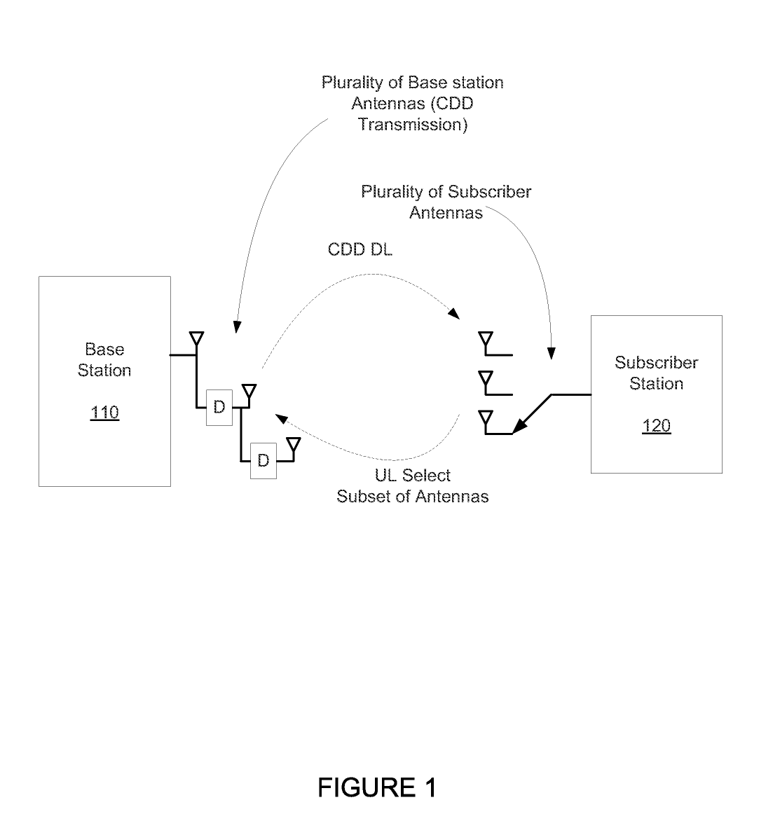

FIG. 1 shows an example of a wireless system that includes a multiple antenna base station transmitting Cyclic Delay Diversity downlink signals to a multiple antenna subscriber station, wherein the subscriber station selects a subset of its antennas for uplink transmission. As shown, a base station 110 includes multiple antennas. Also, as shown, a delay (D) is included between the transmission signals of each of the antennas of the base station 110 during downlink transmission to a subscriber station 120.

The subscriber station 120 receives the CDD downlink (DL) signals through at least one of the multiple subscriber station antennas. Based on a signal quality of received signals through subsets of the multiple subscriber station antennas, the subscriber station 120 selects a subset of the multiple subscriber station antennas for uplink transmission to the base station 110. For embodiment, the subscriber station includes fewer RF chains than antennas, and selects which of the antennas to use for uplink transmission.

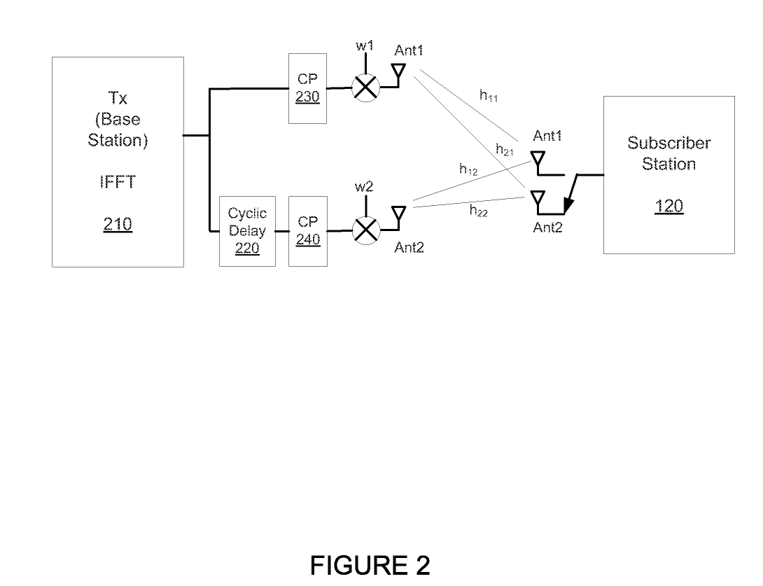

FIG. 2 shows an example of an OFDM (orthogonal frequency division multiplexing) wireless system that includes a multiple antenna base station transmitting Cyclic Delay Diversity downlink signals to a multiple antenna subscriber station. In FIG. 2, the transmitter (210) uses an IFFT (inverse fast Fourier transform) to convert the time domain transmit signal to the frequency domain. The output of the IFFT is sent to a main antenna (Ant 1) after a cyclic prefix (230) has been appended. The output of the CP block (230) is amplitude scaled by a weight w1. The same IFFT output is also connected to a cyclic delay block (220) that introduces a cyclic delayed version of the signal, in which a delay value is (D). A cyclic prefix (240) is appended to the output of the cyclic delayed block, which is amplitude scaled by a weight w2.

While the described embodiments refer to downlink transmission from a base station and uplink transmission from a subscriber station, it is to be understood that the disclosed embodiments can be utilized for communication between any two transceivers. That is, a first transceiver can transmit CDD signals to a second transceiver, and the second transceiver can select a subset of a plurality of signals based upon a signal quality of the received CDD signals.

Cyclic delay diversity (CDD) is a transmit diversity scheme that converts space selective fading into frequency selective fading. In an OFDM system using frequency domain coding (with low enough rates) the diversity from CDD is captured. CDD can be employed on the downlink by a base station (BS) transmitter in order to improve the DL link performance of the subscriber station (SS) when other types of diversity schemes, such as space-time coding (STC) or beamforming (BF), are not suitable or available. One such scenario is the control channel region (MAP zone) in WiMAX (Worldwide Interoperability for Microwave Access), where neither STC nor BF is allowed in the standard from the MAP zone. Failing to decode these control channels leads to the inability to decode the information data. Therefore, using CDD by the BS transmitter improves the DL coverage performance.

Typical UL transmission from the subscriber station (SS) to the BS station uses a single antenna and the BS receiver has multiple receive antennas. However, if the SS has two antennas at its receiver, then the use of MIMO transmission can be used on the UL to improve the link performance. A method of improving the UL transmission using the multiple antennas at the SS is the use of antenna selection. An estimate of the DL channel is derived by the SS receiver, based on the transmission from the BS, the SS transmits from the antenna that resulted in the larger mean received power. With antenna selection transmit diversity as the MIMO technique for the UL, a single RF chain is shared between two antennas. Generally, this assumes that the transmission between the BS and the SS are in a time division duplex (TDD) system, and the transmission channel (uplink and downlink) is reciprocal. The disclosed embodiments combine CDD on the DL with antenna selection on the UL to improve the link performance.

Consider a MIMO system between an SS and a BS which is described in terms of the channel H_{DL} that has dimensions that are given by the number of receive antennas at the SS, i.e. the number of rows of H_{DL} is 2 and the number of transmit antennas at the BS transmitter, i.e. the number of columns can be denoted by N_{T}. Thus, the SS receiver observes the following on its two receive antennas after the FFT processing,

$$y ( f ) = [ \begin{matrix}{y}_{1} ( f ) \\ {y}_{2} ( f )\end{matrix} ] = {H}_{DL} ( f ) x ( f ) + n ( f ) \qquad ( 1 )$$

where f denotes the sub-carrier index, x(f) is a known sequence of transmitted data such as the preamble in WiMAX, and n(f) is the noise plus interference.

A method for improving the uplink performance while still using a single antenna for transmission chain is to use multiple transmit antennas at the SS and allow the selection between those antennas.

The channel responses observed at the SS receiver antennas if no CDD is applied at the BS transmitter, can be given by (this description for a subscriber station equipped with two antennas):

h₁(f)=h₁₁(f)

h₂(f)=h₂₁(f) (2)

where h₁(f) and h₂(f), are the frequency responses of the channel between antenna 1 and 2 of the subscriber station and BS transmit antenna 1, respectively.

Using antenna selection as the UL diversity scheme at the SS, a weight vector applied by the SS transmitter is given by

w=[I(x)I(−x)]^{T} (3)

where the indicator function is given by

$$I ( x ) = \{ \begin{matrix}1 , x \geq 0 \\ 0 , x < 0\end{matrix}$$

and

x=E_{f}[|h₁(f)|²]−E_{f}[|h₂(f)|²] (4)

where the notation E₁[•] denotes the expectation over the set of sub-carriers indexed by f.

The channel responses observed at the SS receiver antennas, 1 and 2, if CDD is applied at the BS transmitter, can be given by

$${\tilde{h}}_{1} ( f ) = \frac{1}{\sqrt{{N}_{T}}} {\sum }_{n = 1}^{{N}_{T}} {h}_{1 n} ( f ) {e}^{- {j2πδ}_{n} f} \\ {\tilde{h}}_{2} ( f ) = \frac{1}{\sqrt{{N}_{T}}} {\sum }_{n = 1}^{{N}_{T}} {h}_{2 n} ( f ) {e}^{- j2π {δ}_{n} f} \qquad ( 5 )$$

Similarly, the weight vector applied at the SS transmitter using antenna selection is given by the indicator function I(x) such that x is now defined as

x=E_{f}[|\tilde{h}₁(f)|²]−E_{f}[|\tilde{h}₂(f)|²] (6)

In order to simplify the mathematical notation, the dependence on the sub-carrier index f is dropped, and thus it is assumed that the channel response is frequency flat. Thus, the argument of the indicator function for the case where the BS doesn't use CDD becomes

x=|h₁₁|²−|h₂₁|² (7)

In the case where the BS uses CDD, the antenna selection decision becomes

$$\begin{matrix}x = \frac{1}{{N}_{T}} {E}_{f} [ {\vert {\sum }_{n = 1}^{{N}_{T}} {h}_{1 n} {e}^{- j 2 π {δ}_{n} f} \vert}^{2} ] - \frac{1}{{N}_{T}} {E}_{f} [ {\vert {\sum }_{n = 1}^{{N}_{T}} {h}_{2 n} {e}^{- j2π {δ}_{n} f} \vert}^{2} ] \\ = \frac{1}{{N}_{T}} {E}_{f} [ {\sum }_{n = 1}^{{N}_{T}} {\sum }_{m = 1}^{{N}_{T}} {h}_{1 n} {h}_{1 m}^{*} {e}^{j2π f ( {δ}_{m} - {δ}_{n} )} ] - \\ \frac{1}{{N}_{T}} {E}_{f} [ {\sum }_{n = 1}^{{N}_{T}} {\sum }_{m = 1}^{{N}_{T}} {h}_{2 n} {h}_{2 m}^{*} {e}^{j 2 π f ( {δ}_{m} - {δ}_{n} )} ]\end{matrix} \qquad ( 8 )$$

which can be simplified to

$$x = {\sum }_{n = 1}^{{N}_{T}} {\vert {h}_{1 n} \vert}^{2} - {\sum }_{n = 1}^{{N}_{T}} {\vert {h}_{2 n} \vert}^{2} + \frac{1}{{N}_{T}} {\sum }_{n = 1}^{{N}_{T}} {\sum }_{m = 1 , m \neq n}^{{N}_{T}} {h}_{1 n} {h}_{1 m}^{*} {E}_{f} [ {e}^{j2π f ( {δ}_{m} - {δ}_{n} )} ] - \frac{1}{{N}_{T}} {\sum }_{n = 1}^{{N}_{T}} {\sum }_{m = 1 , m \neq n}^{{N}_{T}} {h}_{2 n} {h}_{2 m}^{*} {E}_{f} [ {e}^{j2π f ( {δ}_{m} - {δ}_{n} )} ] \qquad ( 9 )$$

Taking the expectation over f (that is, taking the average over frequency), the last two terms of (9) can be shown to vanish, thus (9) reduces to

$$x = {\sum }_{n = 1}^{{N}_{T}} {\vert {h}_{1 n} \vert}^{2} - {\sum }_{n = 1}^{{N}_{T}} {\vert {h}_{2 n} \vert}^{2} \qquad ( 10 )$$

Equation 10 shows that CDD on, for example, the downlink and antenna selection on the uplink provides for a better selection to be made. Namely, selecting the transmit antennas at the subscriber station that provide the most power provides the best uplink transmission to the base station.

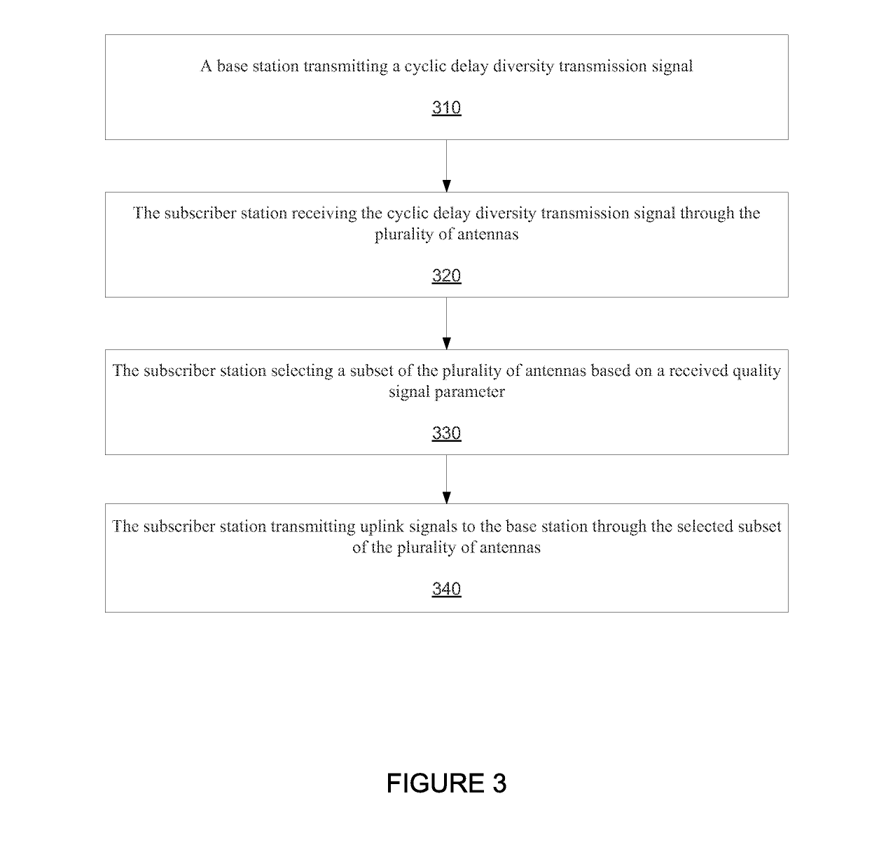

FIG. 3 is a flow chart that includes steps of an example of a method of a subscriber station selecting a subset of a plurality of antennas for uplink transmission. A first step 310 includes a base station transmitting a cyclic delay diversity transmission signal. A second step 320 includes the subscriber station receiving the cyclic delay diversity transmission signal through the plurality of antennas. A third step 330 includes the subscriber station selecting a subset of the plurality of antennas based on a received quality signal parameter. A fourth step 340 includes the subscriber station transmitting uplink signals to the base station through the selected subset of the plurality of antennas.

The benefits of the described embodiments are generally realized through the combination of CDD transmission on the downlink and antenna selection on the uplink. As such, an embodiment includes the base station selecting cyclic delay diversity transmission if the base station has an indication that the subscriber station operating in an uplink transmit diversity mode.

Embodiments include the subscriber station determining the receive signal quality parameter. For an embodiment, the receive signal quality parameter includes a signal to noise ratio (SNR) through each subset of the plurality of antennas. For another embodiment, the receive signal quality parameter includes a channel capacity which can be determined, for example, by log₂(1+SNR) through each subset of the plurality of antennas. For another embodiment, the receive signal quality parameter includes a received signal strength through each subset of the plurality of antennas. For example, the subscriber station receiver operates on y₁(f), y₂(f) instead of \tilde{h}₁(f), \tilde{h}₂(f).

For another embodiment, determining the receive signal quality parameter is influenced by knowledge that the base station is transmitting a cyclic diversity transmission signal. That is, for example, an estimation of a downlink channel can be influenced by a cyclic diversity parameter.

Additionally, for example, the receive signal quality parameter includes an estimated capacity, and the estimated capacity is influenced by the estimated downlink channel. For another example, the receive signal quality parameter includes an estimated signal to noise ratio, and the estimated signal to noise ratio is influenced by the estimated downlink channel.

An additional embodiment includes the base station measuring an uplink channel capacity for more than one subset of the plurality of antennas of the subscriber station, and feeding back to the subscriber station a representation of the capacity for each of the subsets. It is to be understood that other uplink signal quality metric could additionally or alternatively be used (such as received power or SNR). The subscriber station subset selection can be additionally based on the capacity representations received from the base station. For an embodiment this includes signaling between the BS and subscriber about the uplink signal quality metric.

Once a selection of the subset of antenna has been made, the selection can be retained until, for example, a better selection is determined. For an embodiment, a new subset of the plurality of antennas is reselected if the new subset is determined to provide a new received signal quality a threshold better than the received signal quality of the subset. For an embodiment, the threshold adaptively changes over time. For a more specific embodiment, the threshold decreases with time. The threshold is included so that noise and interference doesn't drive the antenna selection decision at the subscriber. The threshold can be chosen based on knowledge of noise and interference levels measured at the subscriber. These measurements can be made from, for example, the received preamble and or pilots of an OFDM frame.

For another embodiment, the threshold is varied depending upon an error rate reported by the base station. For a specific embodiment, the threshold varies based on a number of consecutive NACKs received by the base station. The number of consecutive NACKs that triggers the threshold to vary can be a function of a desired uplink block or packet error rate.

As described above, the CDD transmission is influenced by a cyclic delay parameter. For an embodiment, the subscriber station influences the cyclic delay parameter based on a delay spread measured at the subscriber station. The delay spread is measured based on an estimate of the power delay profile which is estimated from a received preamble in a downlink frame. The power delay profile depicts the amount of energy in the downlink channel as a function of delay (time).

For another embodiment, a plurality of subscriber stations influences the cyclic delay parameter. The plurality of subscriber stations can be identified as the subscriber stations that are proximate to a cell edge. For an embodiment, an average delay spread of the plurality of subscriber stations is used to aid selection of the cyclic delay parameter. Cell edge subscribers can be identified by their low signal plus interference ratios and/or the knowledge of their neighbor set.

For embodiments, delay spread measurements at the subscriber can be used to influence in selection of a subset of a plurality of base station antennas for transmission of the cyclic delay diversity transmission signal. That is, the subscriber station can provide feedback to the base station regarding delay spread measurements made at the subscriber station. The base station's selection of a subset of a plurality of base station antennas for transmission of the cyclic delay diversity transmission signal can be based on the delay spread measurements.

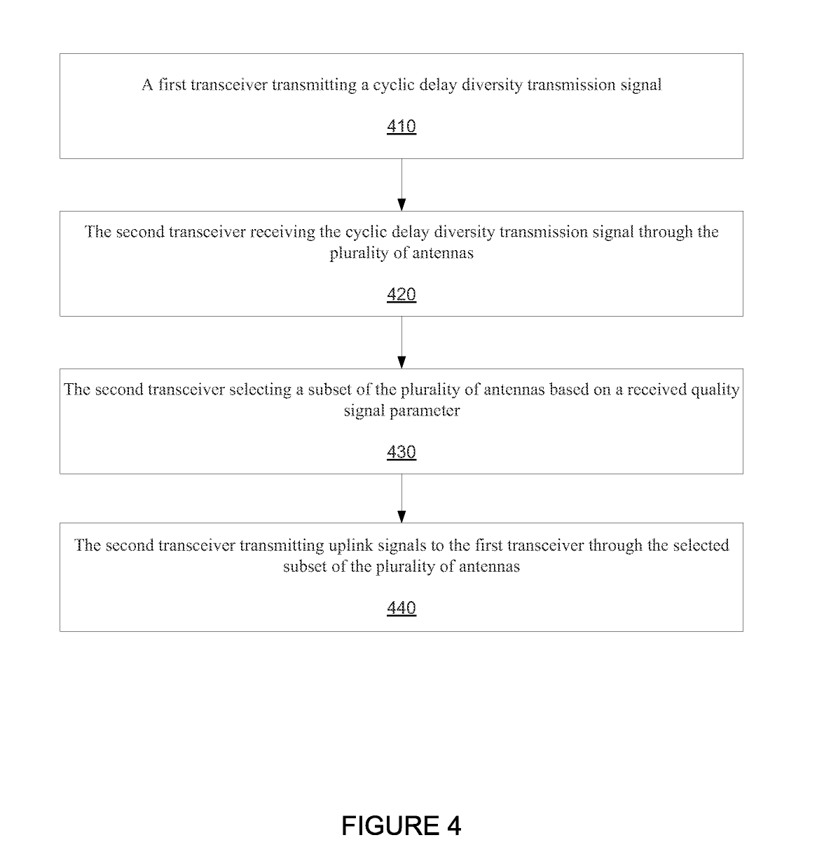

FIG. 4 is a flow chart that includes steps of an example of a method of a second transceiver selecting a subset of a plurality of antennas for second direction transmission. A first step 410 includes a first transceiver transmitting a cyclic delay diversity transmission signal. A second step 420 includes the second transceiver receiving the cyclic delay diversity transmission signal through the plurality of antennas. A third step 430 includes the second transceiver selecting a subset of the plurality of antennas based on a received quality signal parameter. A fourth step 440 includes the second transceiver transmitting uplink signals to the first transceiver through the selected subset of the plurality of antennas.

Although specific embodiments have been described and illustrated, the embodiments are not to be limited to the specific forms or arrangements of parts so described and illustrated. The embodiments are limited only by the appended claims.

What is claimed:

1. A method of a subscriber station selecting a subset of a plurality of antennas for uplink transmission, comprising:
a base station transmitting a cyclic delay diversity transmission signal;
the subscriber station receiving the cyclic delay diversity transmission signal through the plurality of antennas;
the subscriber station selecting a subset of the plurality of antennas based on a received quality signal parameter;
the subscriber station transmitting uplink signals to the base station through the selected subset of the plurality of antennas.

2. The method of claim 1, further comprising the base station selecting cyclic delay diversity transmission if the base station has an indication that the subscriber station operating in an uplink transmit diversity mode.

3. The method of claim 1, further comprising the subscriber station determining the receive signal quality parameter, wherein the receive signal quality parameter includes a channel capacity through each subset of the plurality of antennas.

4. The method of claim 1, further comprising the subscriber station determining the receive signal quality parameter, wherein the receive signal quality parameter includes a signal to noise ratio (SNR) through each subset of the plurality of antennas.

5. The method of claim 1, further comprising the subscriber station determining the receive signal quality parameter, wherein the receive signal quality parameter includes a received signal strength through each subset of the plurality of antennas.

6. The method of claim 1, further comprising the subscriber station determining the receive signal quality parameter, wherein determining the receive signal quality parameter is influenced by knowledge that the base station is transmitting a cyclic diversity transmission signal.

7. The method of claim 6, wherein an estimation of a downlink channel is influenced by a cyclic diversity parameter.

8. The method of claim 7, wherein the receive signal quality parameter includes an estimated capacity, and the estimated capacity is influenced by the estimated downlink channel.

9. The method of claim 7, wherein the receive signal quality parameter includes an estimated signal to noise ratio, and the estimated signal to noise ratio is influenced by the estimated downlink channel.

10. The method of claim 1, further comprising the base station measuring an uplink channel capacity for more than one subset of the plurality of antennas of the subscriber station, and feeding back to the subscriber station a representation of the capacity for each of the subsets.

11. The method of claim 10, further comprising influencing the subscriber station subset selection based on the capacity representations received from the base station.

12. The method of claim 1, further comprising reselecting a new subset of the plurality of antennas if the new subset is determined to provide a new received signal quality a threshold better than the received signal quality of the subset.

13. The method of claim 12, where the threshold adaptively changes over time.

14. The method of claim 13, wherein the threshold decreases with time.

15. The method of claim 13, wherein the threshold is varies depending upon an error rate reported by the base station.

16. The method of claim 13, wherein the threshold varies based on a number of consecutive NACKs received by the base station.

17. The method of claim 1, further comprising the subscriber station influencing a cyclic delay parameter based on a delay spread measured at the subscriber station.

18. The method of claim 17, further comprising a plurality of subscriber stations influencing a cyclic delay parameter, wherein the plurality of subscriber stations are identified as being proximate to a cell edge.

19. The method of claim 18, wherein an average delay spread of the plurality of subscriber stations is used to aid selection of the cyclic delay parameter.

20. The method of claim 1, further comprising the subscriber station influencing the base station in selection of a subset of a plurality of base station antennas for transmission of the cyclic delay diversity transmission signal, based on a delay spread measured at the subscriber station.

21. The method of claim 1, wherein the subscriber station comprises fewer RF chains than antennas.

22. A method of a subscriber station selecting a subset of a plurality of antennas for uplink transmission, comprising:
the subscriber station receiving the cyclic delay diversity transmission signal through the plurality of antennas;
the subscriber station selecting a subset of the plurality of antennas based on a received quality signal parameter;
the subscriber station transmitting uplink signals to a base station through the selected subset of the plurality of antennas.

23. The method of claim 22, further comprising the subscriber station determining the receive signal quality parameter, wherein determining the receive signal quality parameter is influenced by knowledge that the base station is transmitting a cyclic diversity transmission signal.

24. A wireless system, comprising:
an uplink base station transmitting a cyclic delay diversity transmission signal;
a subscriber station receiving the cyclic delay diversity transmission signal through the plurality of antennas, the subscriber station comprising;
a plurality of antennas;
the subscriber station operative to select a subset of the plurality of antennas based on a received quality signal parameter;
the subscriber station operative to transmit uplink signals to the base station through the selected subset of the plurality of antennas.

25. The system of claim 24, further comprising the subscriber station determining the receive signal quality parameter, wherein determining the receive signal quality parameter is influenced by knowledge that the uplink base station is transmitting a cyclic diversity transmission signal.

26. A method of a second transceiver selecting a subset of a plurality of antennas for second direction transmission, comprising:
a first transceiver transmitting a cyclic delay diversity transmission signal;
the second transceiver receiving the cyclic delay diversity transmission signal through the plurality of antennas;
the second transceiver selecting a subset of the plurality of antennas based on a received quality signal parameter;
the second transceiver transmitting uplink signals to the first transceiver through the selected subset of the plurality of antennas.
